(19) United States
(12) Patent Application Publication
(10) Pub. No.: US 2004/0142818 A1
(43) Pub. Date: Jul. 22, 2004

(54) Optically variable pigments used in thermal transfer printing

(76) Inventors: Michael Robert Dayman, Essex (GB); Kelvin Patrick Adkins, Essex (GB)

Correspondence Address: MORGAN LEWIS & BOCKIUS LLP, 1111 PENNSYLVANIA AVENUE NW, WASHINGTON, DC, 20004, US

(21) Appl. No.: 10/477,944

(22) PCT Filed: May 27, 2002
(86) PCT No.: PCT/GB02/02474

(30) Foreign Application Priority Data
May 31, 2001 (GB) 0113117.6

(51) Int. Cl. B41M 5/20

(52) U.S. Cl. 503/201

(57) ABSTRACT

A thermal transfer medium comprises a substrate bearing on at least part of one surface thereof a coating of a thermally transferable ink comprising binder and a plurality of discrete particles of optically variable pigment (OVP) dispersed in the binder. The ink can be printed using convention thermal printing apparatus and methods to produce on an item such as a personalised card an image the optical properties e.g. colour of which vary depending on the angle of viewing, thus constituting a security feature that is difficult to replicate or simulate, enabling the authenticity of the image-bearing item to be readily checked by visual inspection. The invention also concerns a method of malting the thermal transfer medium, a method of thermal transfer printing using the medium and the resulting printed material.

### FIELD OF THE INVENTION

This invention relates to thermal transfer printing, and concerns a thermal transfer medium, a method of making the medium, a method of printing using the medium and the resulting printed material.

### BACKGROUND TO THE INVENTION

Dye diffusion thermal transfer printing is a well known process in which one or more thermally transferable dyes are transferred from selected areas of a dyesheet to a receiver material by localised application of heat, thereby to form an image. Full colour images can be produced in this way using dyes of the three primary colours, yellow, magenta and cyan (Y, M, C). Mass transfer printing is another well known technique in which colorant material (commonly carbon black (K)) is transferred from a mass transfer medium to a receiver material by localised application of heat. Mass transfer printing is generally used to print monochrome images, commonly text, bar codes etc. Dye diffusion thermal transfer printing and mass transfer printing are often used in conjunction with one another, with a common application being the printing of personalised cards such as identification cards, credit cards, driving licences etc, bearing a full colour image of the face of a person and text and/or a bar code in monochrome (usually black).

Such cards are vulnerable to counterfeiting, and the present invention concerns means that can be used to make such cards (and other printed items) harder to replicate or simulate.

The present invention uses for this purpose optically variable pigments (OVP), the optical properties, e.g. colour, of which vary depending on the angle of viewing. Optically variable pigments, which are also known as luster pigments, are described, e.g. in the paper “Luster pigments with optically variable properties” by Schmid et al presented at the 4^{th} Nurnberg Congress (Nurnberg 7-9 Apr. 1997) jointly organised by the Paint Research Association, Teddington, UK and Vincentz Verlag, Hannover, Germany. This paper can be viewed at http://www.2.coatings.de/articles/schmid/schmid.htm and was originally published in the European Coatings Journal June 1997 (issue 7-8).

It is known to use optically variable pigments for security purposes, to render valuable or important documents harder to replicate or simulate and to enable authentication of genuine documents.

U.S. Pat. No. 6,107,244 discloses thermally imageable substrates, such as paper on which is to be thermally printed travel tickets, lottery tickets etc, with the substrates including a light transmissive/reflective platy pigment (i.e. an optically variable pigment). Appropriate information is printed on the substrate using conventional thermal printing apparatus to give a printed article including the pigment. No transfer of optically variable pigment is involved, with the pattern of the pigment being predetermined before printing takes place. The presence of the pigment is difficult to replicate and so provides a security feature indicative of the authenticity of the article.

U.S. Pat. No. 5,648,165 concerns application of optically variable coatings and discloses production of optically variable inks for use in various printing processes such as lithographic printing for providing security-type documents.

U.S. Pat. No. 5,792,579 concerns the preparation of colour filters for visual display applications and discloses interference pigments in a laser ablation process.

### SUMMARY OF THE INVENTION

In one aspect the present invention provides a thermal transfer medium comprising a substrate bearing on at least part of one surface thereof a coating of a thermally transferable ink comprising binder and a plurality of discrete particles of optically variable pigment dispersed in the binder.

The ink can be printed using conventional thermal printing apparatus and methods to produce on an item such as a personalised card an image the optical properties e.g. colour of which vary depending on the angle of viewing, thus constituting a security feature that is difficult to replicate or simulate. For instance, a photocopy of the image will not reproduce the optically variable properties of the ink. The authenticity of the image-bearing item can therefore be readily checked by visual inspection.

Suitable optically variable pigments are known, e.g. as disclosed in the prior art discussed above, and are commercially available. Good results have been obtained with use of the following optically variable pigments: Variocrom Magic Gold K1411 (Variocom Magic Gold K1411 is a Trade Mark) manufactured by BASF; ChromaFlair Gold/Silver 080L (ChromaFlair Gold/Silver 080L is a Trade Mark) manufactured by Flex Products Inc.; Colorstream F10-00 (Colorstream F10-00 is a Trade Mark) which is a silicon dioxide platelet particle coated with ferric oxide, manufactured by Merck Speciality Chemicals; and Mearlin hi-lite super blue & Mearlin hi-lite super violet (Mearlin hi-lite is a Trade Mark) which are mica platelets coated with titanium dioxide, manufactured by Englehard Corporation. A mixture of pigments may be used.

A minor amount (e.g. 1% by weight of the total solids content of the coating) of one or more non-optically variable pigments may also be included in the ink to alter the colour of the ink. For example, use may be made of the black pigment Noir PVC 2E512975 (Noir PVC is a Trade Mark) which is a solid dispersion consisting approx 50% w/w carbon black in a vinylchloride vinylacetate copolymer, manufactured by BASF.

The pigment particles suitably have a particle diameter in the range 0.65 to 200 μm, preferably 2 to 20 μm, preferably with an aspect ratio of at least 2 to 1, with a typical preferred particle having a diameter of about 12 μm and a thickness of about 0.5 μm.

The pigment particles are suitably present in an amount in the range 10 to 70%, preferably 20 to 60%, typically about 35% by weight of the total solids content of the coating.

The binder is usually in the form of a thermoplastic resin, preferably having a Tg in the range 50 to 180° C., selected to imprint print durability and clean transfer characteristics. Suitable binder materials are known in the art, e.g. as disclosed in EP 0283025, and include vinyl chloride/vinyl acetate copolymers, polyester resins, polyvinyl chloride resins, acrylic resins, polyamide resins, polyacetal resins and vinyl resins. A mixture of binders may be used. One currently preferred binder is Vylon GXW-27 (Vylon GXW-27 is a Trade Mark) manufactured by Toyobo, which is a polyester resin having a molecular weight of 20,000 and a Tg of 79° C. Another favoured binder is Vinylite VYHH (Vinylite VYHH is a Trade Mark) which is a copolymer of vinyl chloride/vinyl acetate (86/14 mole %) with a Tg of 72° C. and a molecular weight (Mn) of 20,000 manufactured by Union Carbide. Other favoured binders include Vinylite VYES (Vinylite VYES is a Trade Mark) which is a terpolymer mole with the approximate composition vinylchloride:vinylacetate:other 67:11:22, molecular weight approx 5,500, Tg 53° C., manufactured by Union Carbide; and Neocryl B811 (Neocryl B811 is a Trade Mark) which is a methylmethacrylate homopolymer, molecular weight approx 40,000, Tg 110° C., manufactured by Avecia.

The binder is suitably present in an amount in the range 30 to 90% by weight of the weight of the coating.

The coating preferably also includes one or more fluorescing agents. Suitable agents are known and commercially available, e.g. Uvitex OB (Uvitex OB is a Trade Mark) optical brightener manufactured by Ciba Geigy and Benetex OB (Benetex OB is a Trade Mark) optical brightener manufactured by Mayzo Inc. The fluorescing agent is suitably present in an amount in the range 0.01 to 0.5% by weight of the weight of the coating. Use of a fluorescing agent provides an additional security feature, enabling covert authentication of an image-bearing item by checking for the presence of fluorescence on exposure to ultra violet light.

The substrate may be suitable heat-resistant material such as those known in the art. Suitable substrate materials include films of polyesters, polyamides, polyimides, polycarbonates, polysulphones, polypropylene and cellophane. Biaxially oriented polyester film, particularly polyethylene terephthalate (PET), is currently favoured for its properties of mechanical strength, dimensional stability and heat resistance. The substrate suitably has a thickness in the range 1 to 20 μm, preferably 2 to 10 μm, typically about 6 μm.

The thermal transfer medium preferably includes a subcoat between the substrate and ink coating, particularly in the form of a releasing subcoat to assist release of the coating during printing. One preferred release subcoat comprises a cross-linked acrylic coating.

The thermal transfer medium desirably includes a heat-resistant backcoat, on the side of the substrate not carrying the ink coating, to resist applied heat in use in known manner.

Additional additives may optionally be employed, generally as disclosed in WO 00/50248.

Additional optical effects may be achieved by the use of a clear overlay containing dispersed ultra-fine inorganic materials of high refractive index, on top of a printed optically variable ink image. Such an overlay creates an additional security and/or decorative effect by providing contrast in colour and gloss between the area covered by the overlay and the surrounding OVP printed area. For example, the overlay may be selectively applied on top of the OVP print to reproduce text or a logo. Overlays capable of producing this effect are described, e.g., in U.S. Pat. No. 6,083,873, Example B. To this end the thermal transfer medium may include on part of said surface of the substrate separate from the part bearing the thermally transferable ink coating a coating of a thermally transferable overlay material. Alternatively a separate overlay-carrying substrate may be used.

Additionally, or alternatively, a transparent overlay may be provided over the printed optically variable pigment image to impart additional durability. A suitable overlay for this purpose is disclosed, e.g., in WO 01/12448 Example 3.

The thermal transfer medium is conveniently in the form of a ribbon for use in thermal transfer printing, comprising a substrate having on one surface thereof a plurality of repeated sequences of dye coats, colorants for mass transfer, thermally transferable ink, and optional overlay material, in the form of discrete stripes extending transverse to the length of the ribbon.

Thus in a preferred aspect the invention provides a thermal transfer medium, comprising an elongate strip of substrate material having on one surface thereof a plurality of similar sets of thermally transferable dye coats, mass transfer colorant layers and thermally transferable ink layers, each set comprising a respective coat of each dye colour, yellow, magenta and cyan, a mass transfer colorant layer and a thermally transferable ink layer, each coat or layer being in the form of a discrete stripe extending transverse to the length of the substrate, with the sets arranged in a repeated sequence along the length of the substrate, wherein each thermally transferable ink layer comprises a coating comprising binder and a plurality of discrete particles of optically variable pigment dispersed in the binder.

Such a preferred elongate ribbon-like strip may otherwise be of generally conventional construction, e.g. as disclosed in WO 00/50248.

Each set of the strip may also include a stripe of overlay material, as discussed above.

The order of the dye, colorant and ink stripes on such strips is not important if the different materials are to be printed onto different parts of an item without overlap. However, where overprinting is involved then certain constraints apply. For example, it may be desirable for the optically variable pigment to be printed on top of a coloured image (or part thereof), which may result in the underlying image being clearly visible only at certain angles of viewing. This provides an additional security feature, making it harder to alter, replace or otherwise tamper with the coloured image without it being clearly apparent due to the effect on the overlaid optically variable pigment. Further, it may be desirable for the optically variable pigment to be printed on top of a black mass transfer layer as this can enhance the colour of the pigment. For these reasons, the generally preferred order of stripes on such a strip is yellow, magenta, cyan, black, optically variable pigment, optional overlay (Y, M, C, K, OVP, O).

The stripes of thermally transferable ink layer preferably do not extend across the full width of the substrate, for reasons of economy, as optically variable pigments are expensive and it will generally be appropriate to print only a small area of the ink into an article rather than covering the entire area of an article.

The thermal transfer medium is conveniently made by mixing together the coating materials (binder, pigment and any optional ingredients such as fluorescing agent) and dissolving or dispersing the mixture in a suitable solvent as is well known in the art to give a coating liquid. Suitable solvents include methyl ethyl ketone (MEK), butan-2-one, propanone, tetrahydrofuran, toluene cyclohexanone etc. The coating liquid is then coated on the substrate and dried in known manner, e.g. by bar coating, blade coating, air knife coating, gravure coating, roll coating, screen coating, fountain coating, rod coating, slide coating, curtain coating, doctor coating. The coating suitably has a thickness in the range 0.1 to 10 μm, preferably 0.5 to 7 μm, typically 1.5 to 5.0 μm.

In a further aspect the invention provides a method of making thermal transfer medium, comprising forming on one surface of a substrate a coating of a thermally transferable ink comprising binder and a plurality of discrete particles of optically variable pigment dispersed in the binder.

The thermal transfer medium is used in known manner for printing an image on suitable receiver material. The receiver material is typically in the form of a sheet or card of paper, cardboard, plastics material etc having a suitable image-receiving surface. The thermal transfer medium is placed in contact with the receiver material and localised heating effected to cause localised transfer of the thermally transferable ink to produce image of desired size and shape on the receiver material. When used in conjunction with thermal transfer printing of dyes and mass transfer of colorant material, as discussed above, a full colour image and a monochrome printed area, e.g. a bar code, may also be produced on the receiver material. One common use of the thermal transfer medium is in production of identification cards, typically formed on a sheet of plastics material such as polyvinyl chloride, ABS (acrylonitrile-butadiene-styrene) or polyester, and which may bear a full colour photograph of the face of an individual, produced by thermal transfer printing, in combination with text and/or a bar code produced by mass transfer printing of colorant, as well as an optically variable pigment image.

In a further aspect the invention provides a method of thermal transfer printing comprising superposing a thermal transfer medium in accordance with the invention and a receiver material; applying localised heating to the thermal transfer medium to produce a printed image of optically variable pigment on the receiver material.

The invention also includes within its scope the receiver material after printing, particularly an identification card bearing a full colour image produced by thermal transfer printing and text and/or a bar code produced by mass transfer printing of colorant, in addition to an image of optically variable pigment.

The invention will be farther described, by way of illustration, in the following examples.

### EXAMPLES

### Example 1

A coating solution was prepared from:

| | |
|---|---|
| Vylon GXW-27 (binder) | 25.0% by weight |
| Variocrom Magic Gold K1411 (OVP) | 7.0% by weight |
| Uvitex OB (fluorescing agent) | 0.1% by weight |
| MEK (solvent) | 67.9% by weight |

A coating was applied by hand using a Meier bar to give a wet coat approximately 24 μm thick onto a releasing subcoat pre-coated onto 6 μm thick polyester film. The base film was already coated with a heat resistant backcoat to provide protection from the thermal head during the printing process. The coating was dried initially by a hair dryer, then in an oven at 110° C., for 30 seconds. The dry coat thickness was approximately 7 μm.

The subcoat comprises a highly cross-linked acrylic coating in which the cross-linking is achieved by UV-curing using a combination of photoinitiators and synergists, details of which are given below. The subcoat was coated on the polyester to give a dry coat thickness of approximately 0.6 μm. The subcoat composition, expressed as % w/w, was as follows:

| Chemical | % Composition | Manufacturer |
|---|---|---|
| MIBK | 47.02% | Alcohols Ltd |
| Uvecryl E1354 | 41.88% | UCB Radcure S.A. |
| Diakon MG102 | 5.98% | KDT/Distrupol |
| Irgacure 907 | 1.68% | Ciba Geigy Plastics |
| Uvecryl P101 | 1.67% | UCB Radcure S.A. |
| Quantacure ITX | 0.84% | Lambson Fine Chemicals |
| Quantacure EPD | 0.84% | Lambson Fine Chemicals |
| Cyan dye | 0.08% | |

MIBK is methyl iso-butyl ketone. This is the solvent from which the subcoat layer is deposited. The solvent is evaporated from the coating before it is subjected to UV-curing.

Uvecryl E1354 (Uvecryl 1354 is a Trade Mark) is a hexafunctional aromatic urethane acrylate oligomer.

Diakon MG102 (Diakon MG102 is a Trade Mark) is a high molecular weight grade of poly methylmethacrylate.

Irgacure 907, Uvecryl P101, Quantacure ITX, Quantacure EPD catalyse UV-curing of the Uvecryl E1354. (Irgacure 907, Uvecryl P101 and Quantacure ITX and EPD are Trade Marks).

The resulting coated sheet of film was cut to form a ribbon and was used to print onto the surface of a polyvinyl chloride (PVC) card. The surface of the PVC card consists predominantly of a vinyl chloride/vinyl acetate copolymer (approximately 95:5 weight ratio, respectively). Printing was carried out using an Eltron P300 (Eltron P300 is a Trade Mark) card printer (manufactured by Eltron International Inc.). A colour photograph of a person's face was first printed on an area of the card as a grey scale image at a resolution of 300 dpi by conventional sequential printing of yellow, magenta and cyan dye sublimation dyes using YMCKO Dye sublimation ribbon manufactured by ICI Imagedata. The printed OVP image thus overlaid the colour print of the person's face.

The resulting printed image exhibits a colour shift from gold to silver/bronze when viewed at different angles. This provides an overt security feature. When viewed at an angle of approximately 90° to the card surface under diffuse lighting conditions the underlying image of the face cannot be seen. When viewed at an angle of approximately 20° to the card surface the underlying image of the face is clearly visible. This provides an additional security feature which does not require specialised verification equipment.

When viewed under UV light the mass transfer print exhibits fluorescence emitting blue light. This fluorescence provides a covert security feature to the printed card.

### Example 2

A coating solution was prepared from:

| | |
|---|---|
| Vylon GXW-27 | 23.2% by weight |
| ChromaFlair Gold/Silver 080L (OVP) | 12.3% by weight |
| Uvitex OB | 0.1% by weight |
| MEK | 64.4% by weight |

A mass transfer ribbon was prepared and printed onto a PVC card as described in Example 1.

The resulting printed image exhibits a colour shift from gold to silver when viewed at different angles. This provides an overt security feature. When viewed at an angle of approximately 90° to the card surface under diffuse lighting conditions the underlying image of the face cannot be seen. When viewed at an angle of approximately 20° to the card surface the underlying image of the face is clearly visible. This provides an additional security feature which does not require specialised verification equipment.

When viewed under UV light the mass transfer print exhibits fluorescence emitting blue light. This fluorescence provides a covert security feature to the printed card.

### Examples 3 to 8

A series of further ink coated ribbon samples were prepared as described in Example 1 using a variety of different optically variable pigments and binders as set out below.

The resulting ribbons were printed onto white PVC card as described in Example 1 and also onto cards pre-printed with a mass transfer black ink (K panel from LC1/C YMCKO ribbon, from Ultra Electronics).

| | | % | | % | optically variable | % | additional |
|---|---|---|---|---|---|---|---|
| Example | solvent | w/w | binder | w/w | pigment | w/w | pigment |
| 3 | MEK | 67 | Vylon GXW-27 | 22 | Colorstream F10-00 | 11 | |
| 4 | MEK | 67 | Vylon GXW-27 | 22 | Mearlin hi-lite | 11 | |
| | | | | | super blue | | |
| 5 | MEK | 67 | Vylon GXW-27 | 22 | Mearlin hi-lite | 11 | |
| | | | | | super violet | | |
| 6 | MEK | 79 | Vinylite VYES | 10 | Colourstream F10-00 | 11 | |
| 7 | MEK | 79 | Neocryl B811 | 10 | Colourstream F10-00 | 11 | |
| 8 | MEK | 66 | Vylon GXW-27 | 22 | Colourstream F10-00 | 11 | Noir PVC |
| | | | | | | | 2E512975 |
| | | | | | | | (1% w/w) |

| | printed onto white card | | printed onto pre-printed black card | |
|---|---|---|---|---|
| Example | colour shift | print quality | colour shift | print quality |
| 3 | orange - gold | good | copper-gold | good |
| 4 | colourless - blue | good | light blue - dark blue | good |
| 5 | colourless - purple | good | light purple - | good |
| | | | dark purple | |
| 6 | orange - gold | good | copper - gold | good |
| 7 | orange - gold | good | copper - gold | good |
| 8 | brown - gold | good | copper - brown | good |

1. A thermal transfer medium comprising a substrate bearing on at least part of one surface thereof a coating of a thermally transferable ink comprising binder and a plurality of discrete particles of optically variable pigment dispersed in the binder.

2. A thermal transfer medium according to claim 1, wherein the pigment particles are present in an amount in the range 10 to 70%, preferably 20 to 60%, typically about 35% by weight of the total solids content of the coating.

3. A thermal transfer medium accordingly to claim 1 or 2, wherein the binder comprises a thermoplastic resin, preferably having a Tg in the range 50 to 180° C.

4. A thermal transfer medium according to claim 3, wherein the binder comprises one or more of vinyl chloride/vinyl acetate copolymers, polyester resins, polyvinyl chloride resins, acrylic resins, polyamide resins, polyacetal resins and vinyl resins.

5. A thermal transfer medium according to any one of the preceding claims, wherein the binder is present in an amount in the range 30 to 90% by weight of the weight of the coating.

6. A thermal transfer medium according to any one of the preceding claims, wherein the coating also includes one or more fluorescing agents.

7. A thermal transfer medium according to claim 6, wherein the fluorescing agent is present in an amount in the range 0.01 to 0.5% by weight of the weight of the coating.

8. A thermal transfer medium according to any of the preceding claims, wherein the substrate comprise a film of heat-resistant material selected from polyesters, polyamides, polyimides, polycarbonates, polysulphones, polypropylene and cellophane.

9. A thermal transfer medium according to any one of the preceding claims, wherein the thermal transfer medium includes a subcoat between the substrate and ink coating.

10. A thermal transfer medium according to any one of the preceding claims, wherein the other surface of the substrate has a heat-resistant backcoat.

11. A thermal transfer medium, comprising an elongate strip of substrate material having on one surface thereof a plurality of similar sets of thermally transferable dye coats, mass transfer colorant layers and thermally transferable ink layers, each set comprising a respective coat of each dye colour, yellow, magenta and cyan, a mass transfer colorant layer and a thermally transferable ink layer, each coat or layer being in the form of a discrete stripe extending transverse to the length of the substrate, with the sets arranged in a repeated sequence along the length of the substrate, wherein each thermally transferable ink layer comprises a coating comprising binder and a plurality of discrete particles of optically variable pigment dispersed in the binder.

12. A method of making thermal transfer medium, comprising forming on one surface of a substrate a coating of a thermally transferable ink comprising binder and a plurality of discrete particles of optically variable pigment dispersed in the binder.

13. A method of thermal transfer printing comprising superposing the thermal transfer medium in accordance with any one of claims 1 to 11 and a receiver material; applying localised heating to the thermal transfer medium to produce a printed image of optically variable pigment on the receiver material.

14. Receiver material bearing a printed image produced by the method of claim 13.

15. Receiver material according to claim 14, in the form of an identification card bearing a full colour image produced by thermal transfer printing and text and/or a bar code produced by mass transfer printing of colorant, in addition to an image of optically variable pigment.
